(19) United States
(12) Patent Application Publication
(10) Pub. No.: US 2022/0322654 A1
(43) Pub. Date: Oct. 13, 2022

(54) HEAT-ENERGIZED EMANATOR FOR A VOLATILE SUBSTANCE

(71) Applicant: Microlin, LLC, Salt Lake City, UT (US)

(72) Inventor: Ashok V. Joshi, Salt Lake City, UT (US)

(21) Appl. No.: 17/717,068

(22) Filed: Apr. 9, 2022

Related U.S. Application Data
(60) Provisional application No. 63/173,934, filed on Apr. 12, 2021.

(51) Int. Cl. A01M 29/12; B05B 1/24

(52) U.S. Cl. CPC A01M 29/12; B05B 1/24

(57) ABSTRACT

An apparatus including a heat source coupled with a container of volatile substance to enhance broadcast of the volatile substance in vapor phase from an emanator element into a local gas environment. A heat source non-exclusively includes any combustible arrangement to produce a flame. Volatile substance may be associated with the emanator element in liquid or a non-spillable solid or solidified phase. Heat may be directed toward the volatile substance using any of convection, radiation, and conduction. A chimney may focus a convective draft to increase draft air speed, and/or orient the draft in a desired (e.g., non-vertical) direction. A mechanism may permit adjustment in spacing between volatile substance and the flame. A seal may resist undesired discharge of volatile substance (in liquid and/or vapor phase), prior to use.

### RELATED APPLICATIONS

This application claims the benefit under 35 U.S.C. 119(e) of the filing date of Provisional Application Ser. No. 63/173,934, filed Apr. 12, 2021, for “FLAME-ENERGIZED EMANATOR”, the entire content of which is incorporated herein by reference.

### BACKGROUND

### Field of the Invention

This invention relates to devices configured to broadcast a volatile fluid or substance in vapor phase into a local gas environment.

### State of the Art

It is known to broadcast fluid in vapor or fine particulate misted form for various reasons. For example, insect repellant or insecticide in aerosol or vapor phase is commonly broadcast into a local gas environment to control nuisance insects. Certain devices are commercially available to apply insecticides as a fog. One representative such device uses a propane-fired heating element to heat a fluid insecticide to create the fog. Aerosol-driven cans of treatment fluids are also commercially available, and may be used to spray a fine mist of insecticide or repellant into a local atmosphere. Citronella and other scented candles are available for burning to broadcast their scent into a local environment to provide a measure of insect control. It has been determined that the available products are either too expensive, cumbersome to use, and/or lack efficacy. It would be an improvement to provide better devices for broadcasting fluid in vapor phase into a local environment.

### BRIEF SUMMARY OF THE INVENTION

In general, embodiments may be arranged to provide a portable volatile substance delivery device including a volatile substance (e.g., a treatment fluid) placed in thermal communication with a heat producing element or mechanism. One workable heat producing element propagates heat from a flame that consumes some sort of fuel. Another exemplary heat producing element includes a thermo-electric heater in combination with a source of electricity, such as a battery or utility. Certain embodiments may be disposable after an inherent fixed interval of operation. Other embodiments may be rechargeable, or simply capable of intermittent operation over an extended life.

One preferred embodiment is configured for operation over a time interval that lasts for somewhere between about 3 and 8 hours, or so. Typically, that embodiment is discarded after a single use. Another embodiment may be operated intermittently for a longer cumulative life of operation. It is within contemplation that a cumulative life may last for a total of 200 hours, or even more. Desirably, an embodiment can emit treatment vapor for at least the duration of an event, such as a backyard BBQ, or party. The interval of operation may be determined by provision of a fixed quantity of fuel, a fixed quantity of treatment agent or volatile substance, a termination timer mechanism, or an arrangement to permit manual termination.

One workable heat producer includes a candle or lantern. A currently preferred heat producer includes a combustion wick in communication with a quantity of combustible fluid fuel, such as paraffin oil. A desired amount of combustible fluid may be confined in a bottle or other container. A workable combustion wick is operable to draw the combustible fluid from the container for burning in a flame to produce heat. Desirably, the flame is at least substantially smoke-free. In any case, the heat released from the flame can be harnessed in various ways to volatize a target treatment fluid or other substance for emanation of treatment vapor into the surrounding gas environment. Certain embodiments may also cause, promote, or enhance air circulation over a quantity of fluid or loaded carrier material to facilitate evaporation of the volatile treatment substance.

Volatile treatment substances within contemplation include insect control chemicals, pest control chemicals, essential oils, and medicant chemicals. More specifically, operable insect control chemicals may include one or more of Deet, Picardine, Icaradin, IR3535, prethroid residues, allethrin, deltamethrin, Metofluthrin, transfluthrin, esbiothrin, prallethrin, 1-methylpiperazine, or Permethrine, as well as Natural chemicals such as citriodiol and Oil of Lemon Eucalyptus.

An exemplary assembly according to certain principles of the invention includes: a source of combustible fuel, a container for volatile fluid, a quantity of volatile fluid in the container, and an emanator element. The assembly is configured for burning the fuel in a flame to produce heat. A portion of the container is disposed in a heat conducting path extending to the flame. A heat conducting element disposed in the heat conducting path may include air, a wall of the container, a metallic bridge element, and the like. The emanator element is associated with the volatile fluid to release volatized fluid in vapor phase into an ambient gas environment. Sometimes, a removable seal element can be provided to resist undesired broadcast of fluid in vapor phase from the apparatus.

A workable heat source includes anything burnable to produce a flame, such as a wax candle, a fuel burning lantern such as an oil or kerosene lantern, a charcoal briquette, and the like. One currently preferred heat source includes a commercially available, low-cost, paraffin oil lantern. As mentioned above, non-flame-based heating elements, such as thermoelectric devices, may be employed in certain alternative devices.

Certain embodiments may also include an auxiliary heat conducting element. When present, the heat conducting element is configured and arranged to facilitate introduction of the heat into the volatile fluid or substance to volatize the fluid or substance. A workable heat conducting element includes a material having a thermal conductivity k greater than about 100 w/(m deg.K). A currently preferred heat conducting element includes an elongate heat transfer element with a first end portion disposed for contact with a flame, and a second end portion disposed to transfer heat from the flame to a volatile fluid or substance. Suitable heat conducting elements may have a thermal conductivity k of 200, 250, 300, 350 w/(m deg.K), or more. A workable elongate heat transfer element made from Copper has a thermal conductivity k of about 386 w/(m deg.K). One exemplary embodiment includes a volatile fluid in liquid phase confined in the container; a first portion of a ceramic wick dipped into the volatile fluid; a second portion of the ceramic wick disposed external to the container to operate as an emanator element; and a metallic heat conducting element disposed between the flame and the second portion of the wick.

One or more seal element may be associated with a constituent element or the entire assembly to resist undesired escape of a fluid in either liquid or vapor phase. A workable seal element may be embodied as a stopper, cork, lid, foil envelope, plastic bag, and the like. Fluid carried by an assembly may include either or both of fuel and volatile fluid. Volatile fluid disposed inside a container may be in liquid or non-liquid form. Sometimes, it is desired to configure volatile fluid in a non-liquid form to directly resist undesired spill of volatile liquid from the assembly.

An emanator element generally includes a surface from which fluid in vapor phase can propagate into a gas environment. It is within contemplation that a portion of the container may operate as the emanator element. In that case, the emanator element can include a volume in which to hold a portion of the quantity of volatile fluid.

An assembly typically includes a holder configured to position the container at a desired position with respect to a flame or other heat source. Although not required, the holder may be configured to permit a user to vary a distance between a heat source and the volatile fluid or substance.

One currently preferred embodiment includes a holder configured to provide a space of greater than about two inches between the heat source and a container of volatile substance. An exemplary holder includes a chimney configured to focus circulation of air heated by the flame for contact of heated air with a container. Sometimes, an emanator element may be disposed around a circumference of a portion of the chimney, or may be carried by or attached in some way to the chimney. An emanator element may be carried by a chimney structured to telescopically reciprocate with respect to a base to vary a distance between a flame or other heat source and the volatile fluid or substance. A chimney may be arranged to direct flow of air heated by the flame toward the container such that a vector defining median air flow direction for air in the vicinity of the container is disposed at an angle with respect to vertical. In certain cases, the angle may be greater than about 25 degrees. In other cases, the angle may be greater than about 45 degrees. It is within contemplation that the angle may even be about 90 degrees, or more. Sometimes, a solvent vapor may be directed by a chimney to facilitate volatization of a less volatile material.

Certain embodiments of workable assemblies may be constructed of sufficiently low-cost elements as to permit disposal after one-time-use. For example, at time of this writing, an assembly that may fairly be characterized as being disposable after a single use will have a manufacturing cost of less than $0.50. Exemplary such assemblies may be configured for operation over a maximum period of time of less than about 8 hours.

In other cases, an assembly may be constructed for start and stop on-demand operation over a plurality of individual time periods, a sum of the individual time periods providing a maximum total time of operation that is greater than about 100 or 200 hours. Assemblies may include suitable electronic controls to operate for a specific amount of time each time with an auto shut off as safety feature. Such long-life devices may include a heat source and emanator configured for similar long life without requiring refueling or topping-off.

One assembly according to certain principles of the invention includes an oil lamp sized to hold only that amount of fuel that permits the lamp to feed a flame for 8 hours or less by wicking the fuel from a lamp storage compartment to the flame to produce heat. A container for volatile fluid is arranged such that a portion of the container is disposed to receive heat from the flame. A quantity of volatile fluid is disposed inside the container. A holder is provided to dispose the container at an operable elevation above, and distance from, a top of the flame. An emanator element is associated with the volatile fluid and configured to release the volatile fluid in vapor phase into an ambient gas environment. The assembly may also include a removable seal element configured to resist undesired broadcast of fluid in vapor phase from the apparatus prior to intended use of the apparatus. In certain cases, the holder can be configured to provide a height-adjustable path between a flame or heat source and a container. A height-adjustable path may provide a user control over temperature and convention applied onto a volatile substance. Sometimes, a volatile fluid is stored in the container in solidized form to resist spilling of liquid from the apparatus. Embodiments may also include one or more heat conducting element, such as an elongate element with a first end portion disposed for contact with the flame, and a second end portion disposed to transfer heat from the flame to the fluid, the elongate element having a thermal conductivity greater than about 200 w/(m deg.K). In certain cases, the container operates as the emanator element, and the emanator element comprises a volume in which to hold the quantity of fluid.

Another embodiment includes a source of combustible fuel arranged for burning the fuel in a flame to produce heat; a container for volatile fluid; a quantity of volatile fluid disposed inside the container; an emanator element associated with the volatile fluid and configured to release volatile fluid in vapor phase into an ambient gas environment responsive to application of heat from the flame to volatile fluid disposed in the emanator element or container; a chimney configured and arranged to direct a convection air current along a non-vertical path from the vicinity of the flame toward the emanator element; and a removable seal element configured to resist undesired broadcast of fluid in vapor phase from the apparatus prior to intended use of the apparatus.

### BRIEF DESCRIPTION OF THE DRAWINGS

In the drawings, which illustrate what are currently considered to be the best modes for carrying out the invention:

FIG. 1 is a schematic view of a generalized representation of embodiments within the ambit of the instant invention;

FIGS. 2 through 10 are schematic views in elevation of embodiments according to certain principles of the instant invention;

FIG. 11A is an X-Y plot of performance data over time for the embodiment in FIG. 11B;

FIG. 11B is a schematic view in elevation of an embodiment according to certain principles of the instant invention;

FIG. 12A is an X-Y plot of performance data over time for the embodiment in FIG. 12B;

FIG. 12B is a schematic view in elevation of an embodiment according to certain principles of the instant invention;

FIG. 13A is an X-Y plot of performance data over time for the embodiment in FIG. 13B;

FIG. 13B is a schematic view in elevation of an embodiment according to certain principles of the instant invention;

FIG. 14A is an X-Y plot of performance data over time for the embodiment in FIG. 14B; and

FIG. 14B is a schematic view in elevation of an embodiment according to certain principles of the instant invention.

### DETAILED DESCRIPTION OF THE ILLUSTRATED EMBODIMENTS

Reference will now be made to the drawings in which the various elements of the illustrated embodiments will be given numerical designations and in which the invention will be discussed so as to enable one skilled in the art to make and use the invention. It is to be understood that the following description is only exemplary of certain principles of the present invention, and should not be viewed as narrowing the claims which follow.

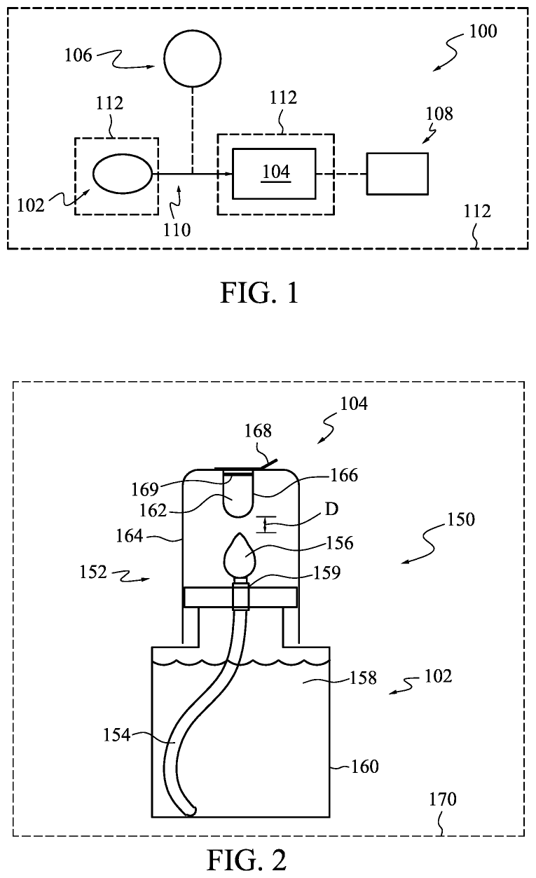

FIG. 1 generically illustrates a flame-energized emanator assembly, generally 100, structured according to certain principles of the invention. Embodiments of an energized emanator assembly 100 are typically self-contained, and desirably are portable to permit a person to easily move the emanator assembly 100 to a desired location for operation to treat a local environment. Energized emanator assemblies 100 are conventionally used to apply a treatment fluid in vapor phase to a local atmospheric or gas environment. Desirable treatment fluids may sometimes have relatively low volatility, and consequently, emanation of a vapor from those or other fluids may be enhanced to an efficacious degree by the energizing portion of an emanator assembly 100.

Embodiments 100 may be used, for nonexclusive examples, to treat a local atmosphere with a pleasing scent, beneficial treatment agent, or insect repellant. Examples may be discussed below with reference to a particular fluid, such as insect repellant, but no limitation to any particular fluid is intended. Certain embodiments 100 may be disposable after a single-use. Other embodiments 100 may be capable of interruption to permit use over a plurality of spaced-apart times, or may be recharged or regenerated to operate a plurality of times in succession. An emanator assembly 100 according to certain principles of the invention may operate for a period of several hours, one or more days, weeks, months, or even longer. It is within contemplation that part or all of an emanator assembly 100 may be structured to facilitate its biodegradability.

As illustrated in FIG. 1, an energized emanator assembly 100 may include an energizing mechanism, generally 102, and an emanating element 104. An operable energizing mechanism 102 typically functions in some way to increase emanation of a volatile fluid from the emanating element 104 to an enhanced rate compared to a conventional rate of emanation. For example, a conventional rate is achievable from a comparable surface area of a quantity of volatile fluid at room temperature and under undisturbed atmospheric conditions.

Exemplary energizing mechanisms 102 nonexclusively include one or more heat source. Sometimes, an embodiment may include effervescing, gas-producing, or gas-moving mechanisms. An energizing mechanism 102 may create an enhancement environment to produce a desired effect or action on an emanating element to enhance emanation of vapor of a treatment fluid. One enhancement environment within contemplation includes an elevated temperature that enhances evaporation of fluid from an emanator element. Another enhancement environment within contemplation includes a draft or air flow to enhance evaporation of fluid from the emanating element. Energizing heat-producing mechanisms according to the instant invention are distinguished from battery operated, electrically plugged-in, and chemically exothermic without a flame.

An emanator assembly 100 may include an initiation trigger mechanism, generally indicated at 106, to start an energizing process, and thereby, to start an enhanced rate of emanation of treatment fluid in a vapor form from the emanating element 104. Exemplary initiation trigger mechanisms 106 nonexclusively include structure arranged to permit lighting a wick, or otherwise initiating a flame for consumption of a fuel. An exemplary initiation trigger mechanism 106 may include a removable cap or cover associated with the emanator element 104 or with the energizing mechanism 102. Simply removing a cover or seal element may be sufficient to initiate broadcasting of the volatile fluid in vapor phase into the local gas environment. Certain trigger mechanisms 106 may be configured to cause on-demand sparking, to light a flame. Certain embodiments of a trigger mechanism 106 may include a safety to resist unintended actuation.

Sometimes, an emanator assembly 100 may include a termination mechanism, generally indicated at 108, to stop the enhanced rate of emanation. Exemplary termination mechanisms 108 nonexclusively include: structure arranged to permit one or more of: sealing or resealing part or all of an emanator inside an air-tight envelope; removal of the volatile fluid from an energizing environment of the emanator; or extinguishing the heat source, and the like.

Still with reference to FIG. 1, an energized emanator assembly 100 desirably includes a coupling mechanism 110 to operably associate an energizing mechanism 102 with an emanating element 104. A workable coupling mechanism 110 can be configured to hold an energizing mechanism 102 at a desired position with respect to an emanating element 104. Sometimes, a coupling mechanism 110 may be adjustable to vary a distance between energizer 102 and emanator 104. One operable coupling mechanism 110 may transform an assembly 100 from a small size (e.g., for storage and/or sale packaging) to a larger deployed size. For example, a mechanism 110 may include a telescopic portion.

In a case where the energizing mechanism 102 includes a heat source, an operable coupling mechanism 110 may include a simple heat transfer element, such as a thermally conductive metal or other element, to convey heat toward a quantity of treatment fluid. In a case where the energizing mechanism 110 includes a gas generating element, a coupling mechanism 110 may include ducting to direct gas flow in a desired direction. In certain cases, gas generation may be caused within a medium, and the generated gas may promote evolution of treatment fluid in vapor phase from within the medium.

Still with reference to FIG. 1, it is generally preferred to include a seal element 112 to resist loss of fluid in liquid phase from confinement in the embodiment 100 or a constituent element thereof. Sometimes, a seal 112 may be embodied to even resist escape of fluid in vapor phase from confinement somewhere in an assembly 100. A workable seal 112 may sometimes be provided in a conveniently removable form, such as a tear-off foil or plastic membrane disposed to temporarily block an orifice. Other times, a seal 112 may be embodied as a substantially permanent portion of an emanator assembly 100. Certain seals 112 may be embodied as a removable envelope or bag.

The embodiment illustrated in FIG. 2, and generally indicated at 150, is exemplary of an energized emanator assembly 100 according to certain principles of the invention. Every illustrated and described element is encompassed within an embodiment 100. The illustrated energizing mechanism 102 includes an oil lamp, generally 152, with a wick 154 to provide fuel to a flame 156. Workable lamps 152 are commercially available. Certain commercially available lamps 152 are surprisingly inexpensive, and may be considered as being disposable after a single use. Lamps 152 in certain currently preferred embodiments are inherently operable for a maximum time interval of between 4 and 8 hours. Desirably, a lamp 152 includes a fuel seal 159 constructed to resist undesired leaking of fuel oil 158 from the fuel container 160. Fuel seal 159 is exemplary of a seal element 112 (FIG. 1) that is particularly associated with fuel container 160. A time of operation may be determined by the amount of fuel oil 158 in the fuel container 160.

Still with reference to FIG. 2, a volatile fluid 162 is disposed above the flame's conventional operating location by way of a vented shroud 164. An operable shroud 164 may include a portion of mesh screening (metal, fiberglass, plastic, etc.). Sometimes, the distance or spacing “D” between volatile fluid 162 and flame 156 may be a user-adjustable parameter. Other times, the distance “D” may be fixed to provide a predetermined spacing. The amount of heat imparted to the fluid 162 may be modeled as a function including spacing “D” and flame size.

In FIG. 2, the emanator element 104 includes a quantity of volatile fluid 162 held in an initially sealed fluid-tight holder 166 to resist undesired loss of fluid. A fluid-tight seal 168 may be removed by the user at the time of desired operation. Desirably, seal 168 is also effective to resist escape of volatile fluid in vapor phase from the container 166. Sometimes, a porous membrane 169 may be included to resist loss of liquid from container 166 after seal 168 is removed. In that case, it is desirable for membrane 169 to permit egress of volatized fluid in vapor phase.

Seals 168 and 169 are exemplary of seal elements 112 illustrated in FIG. 1. Bag or envelope 170 is exemplary of another instance of a seal 112 element in FIG. 1. Typically, an energized emanator assembly 100 is sealed inside an envelope 170 for storage prior to sale. Desirably, the storage envelope 170 is resistant to escape of fluid in both liquid and gas phases.

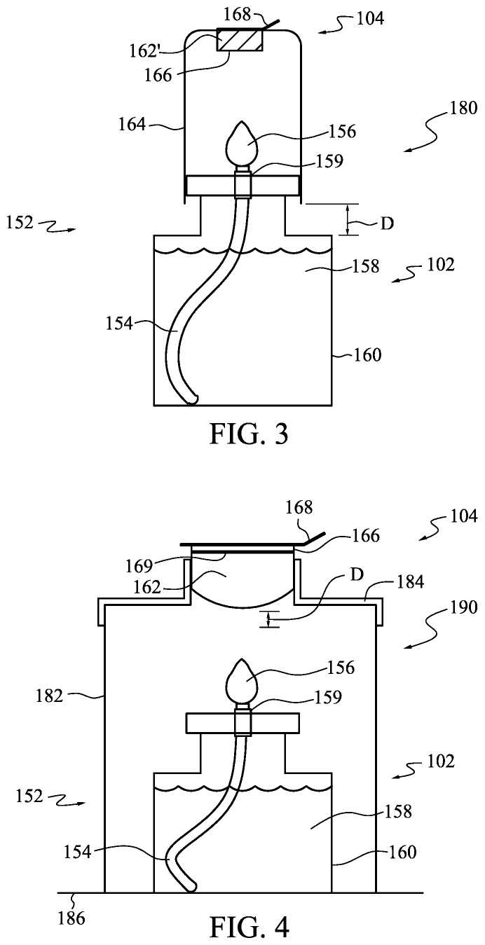

The embodiment illustrated in FIG. 3, and generally indicated at 180, is exemplary of an energized emanator assembly 100 according to certain principles of the invention. Every illustrated and described element is encompassed within an embodiment 100. Embodiment 160 is generally similar to embodiment 150, and like elements are identified with like numerals. However, embodiment 160 includes treatment agent 162′ arranged in a solidified form to resist undesired fluid leaking. Desirably, removable seal 168 cooperates with container 166 to resist undesired escape of fluid in volatile phase.

Volatile fluid 162 may be placed in a solidified form 162′ by loading treatment fluid 162 into a substrate or carrier material. In one example, a treatment fluid 162 may be instilled into a substrate material that is absorbent. Exemplary absorbent materials nonexclusively include: cotton, paper, natural and synthetic fibers in a woven or mat arrangement, cellulose, ceramic foam absorbent, and the like. Solidized treatment fluid 162′ may also be formed by adsorbing treatment fluid into a carrier material such as styrene, butadiene, or other suitable rubber, or into a high surface area material. By high surface area (HSA), it is intended to mean a material having surface area greater than 10 m2/g. Workable HSA materials may have a surface are greater than 20, 50, 100, 300, 500, and 600 m2/g. HSA materials having surface area of 2,000 or even 10,000 m2/g, or even more, are within contemplation.

Workable HSA materials include activated carbon, activated Alumina, activated Titanium oxide, (e.g., activated ceramics), metal/organic high surface area compounds, high surface area Silica, zeolites, molecular sieves, and the like. Such materials may be fabricated and used as powders, granules, beads, chunks, sheets, and/or formed into particular functional structures, and the like.

The embodiment illustrated in FIG. 4, and generally indicated at 190, is exemplary of an energized emanator assembly 100 according to certain principles of the invention. Every illustrated and described element is encompassed within an embodiment 100. A perforated or mesh housing 182 forms an exemplary coupling mechanism 110, and can sometimes variably associate the emanating element 104 of treatment fluid with an energizing mechanism 102 (e.g., oil lamp 152). For example, cup 166 may slide vertically with respect to cap 184, and/or cap 184 may slide vertically with respect to walls of housing 184 to effect a change in adjustable distance “D” between flame 156 and fluid 162. The illustrated housing 184 may be cylindrical, rectangular, poly-sided, or pyramidal, or have a cross-section formed in any other operable configuration. A workable housing 184 may be made from mesh or screen composed of metal, fiberglass, or plastic, and the like.

As illustrated in FIG. 4, a seal 168 may be provided for a fluid-holding cup 166 to resist premature or undesired broadcast of treatment fluid or fumes from the emanating element 104. Heat provided by the flame to the treatment fluid may be conveyed by any or all of radiation, convention, and conduction. Variables that may be adjusted as desired nonexclusively include: vertical spacing or separation; flame size; and thermal properties and conformation of the cup material.

In operation of one embodiment 190, a flame source (such as a candle or lantern 152), may be lit and placed onto a convenient support surface 186 in a location to provide treatment to a local gas environment. Then, the housing 184 may simply be dropped in place over the lit flame 156. If present, a seal element 168 may be removed from the container 166 of treatment fluid 162, and the device 180 may be left to operate autonomously. Sometimes, a spacing between flame and emanator may be adjusted as desired; either before or during operation.

One single-use embodiment 190 constructed according to FIG. 4 lasted about 8 hours. The paraffin lantern 152 had an outside diameter of about 1″ and a total height of less than about 2″. The inside diameter of the fuel bottle 160 was about ⅗″, and bottle 160 was substantially filled with paraffin oil. The bottom of a glass cup 166 was about 1½″ above the top of flame 156. A metofluthrin solution (an exemplary volatile fluid 162) was placed into the open cup 166. That tested embodiment achieved a volatization rate of between 100 to 250 mgms of 4% metofluthrin solution per hour for insect repellency.

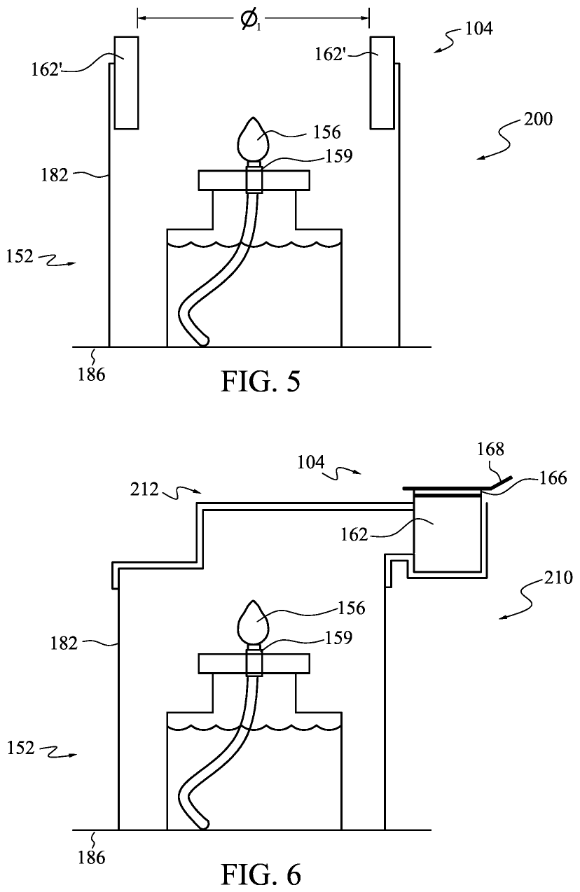

The embodiment illustrated in FIG. 5, and generally indicated at 200, is exemplary of an energized emanator assembly 100 according to certain principles of the invention. Every illustrated and described element is encompassed within an embodiment 100. Embodiment 200 is generally similar to embodiment 190, but includes an opening having an emanating element 104 disposed around its circumference. A workable emanating element 104 includes a length portion of a commercially available cotton or woven fabric wick (such as might be used in a kerosene lantern). Exemplary wick materials nonexclusively include cellulose paper, plastic, fiberglass, or ceramic foam absorbent. The wick may be simply fastened to the wall of the housing 182.

Embodiments 200 having emanator elements 104 with 1½ inch and 2.2 inch diameters were tested, without detection of a noticeable difference in efficacy. The total height of these tested devices was about 6 to 8 inches, and flame height was about 1.5 to 2 inches. Closest distance between flame and emanator edge is estimated to have been about 4 inches.

The embodiment illustrated in FIG. 6, and generally indicated at 210, is exemplary of an energized emanator assembly 100 according to certain principles of the invention. Every illustrated and described element is encompassed within an embodiment 100. The embodiment in FIG. 6 illustrates application of ducting, generally indicated at 212, to transport heat from a flame 156 to a convenient location for application to an emanator element 104. The amount of applied heat may be further controlled by conformation and materials of construction of the ducting 212.

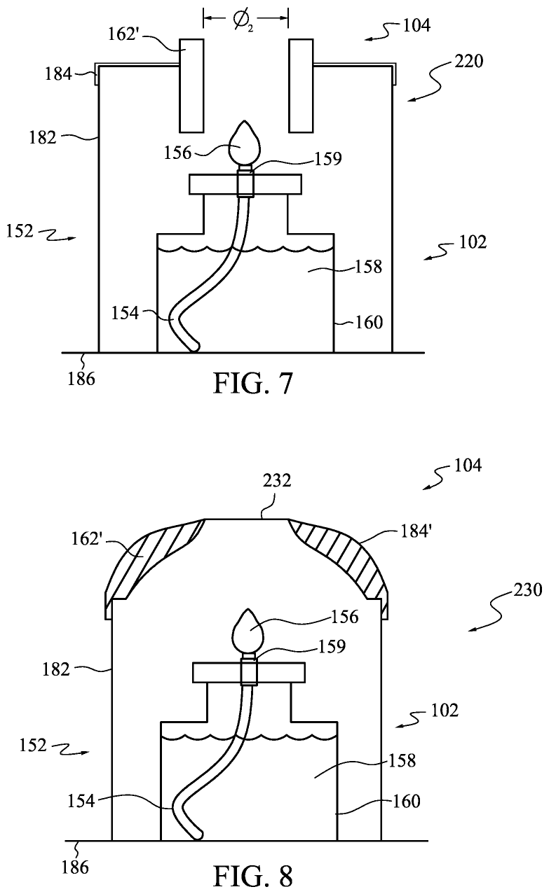

The embodiment illustrated in FIG. 7, and generally indicated at 220, is exemplary of an energized emanator assembly 100 according to certain principles of the invention. Every illustrated and described element is encompassed within an embodiment 100. Embodiment 220 may be generally similar to embodiment 200, but includes a smaller diameter emanator element 104 carried by a cap element 184. The location of the emanator is more vertically in line with the flame 156, and consequently more heat energy is imparted into the emanator. Spacing between the flame 156 and emanator element 104 may be adjusted by lifting the lid 184 with respect to a wall of the housing 182, or simply by providing taller or shorter walls.

The embodiment illustrated in FIG. 8, and generally indicated at 230, is exemplary of an energized emanator assembly 100 according to certain principles of the invention. Every illustrated and described element is encompassed within an embodiment 100. Embodiment 230 is somewhat similar to embodiments 200 and 220, except that the emanator element 104 is disposed as a generally toroid or donut-like element carried by the dome-shaped lid 184′. Embodiment 230 illustrates a solid-walled housing and a perforated dome lid 184′. A workable lid 184′ may be made from a mesh or screen 232 with sufficient material properties to resist any potential heat from the flame and support the weight of volatile fluid 162′ in the emanator element 104.

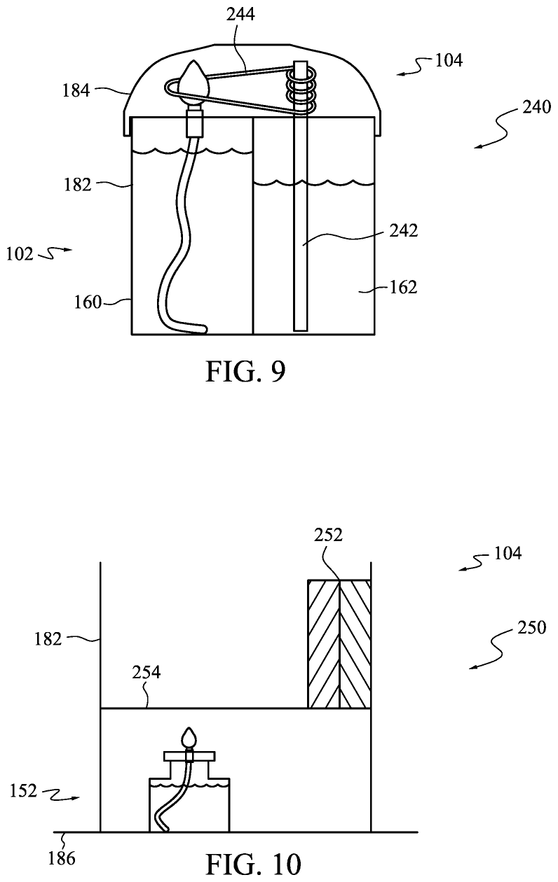

The embodiment illustrated in FIG. 9, and generally indicated at 240, is exemplary of an energized emanator assembly 100 according to certain principles of the invention. Every illustrated and described element in FIG. 9 is encompassed within an embodiment 100. Embodiment 240 illustrates coupling a flame 156 to a heat transferring wick 242 with an intermediate heat transfer element 244, such as Copper or other heat-conductive material. Alternatively, a heat transferring element 244 may thermally couple a heat source to a container or to an emanator to enhance evolution of vapor.

As illustrated in FIG. 9, the heat transfer element 244 includes an elongate element with a first end portion disposed for contact with the flame, and a second end portion disposed to transfer heat from the flame to the volatile fluid. A space between flame 156 and wick 242 is sometimes desirably greater than about ½ inch, e.g., to avoid flame contact with a combustible wick. Desirably, the elongate heat transfer element 244 has a thermal conductivity greater than about 100 w/(m deg.K).

A workable heat transferring wick 242 may be made from ceramic or glass, or other suitably conductive and/or wicking element. A wick typically functions to extract volatile substance from a bulk supply. It is within contemplation that the wick 242 may be alternatively be embodied in the heat-coupling element 244 to provide a more direct heat transfer from flame 156 to fluid 162 or 162′. In either case, the heat energy from an energizing mechanism 102 (e.g., candle, lantern, or other fuel-burning device), can be imparted through one or more intervening heat transfer element 244 to a portion of a bulk quantity of a volatile treatment fluid 162, or to a volatile substance in solid or solidified form.

One benefit provided by embodiment 240 is the capability to easily interrupt, and restart, vapor broadcasting operation of the emanator assembly 240 a plurality of times. The volume of treatment fluid 162 and fuel 158 may be adjusted to permit cumulative operation for 40 hours, or more. Certain embodiments may be inherently capable of operation for an extended period of time, including over 100 hours, 200 hours, or more. Desirably, bulk fuel containers 160 are resealable. In certain cases, one or more bulk fuel container 160 may be recharged or refilled to extend an embodiment's operable lifetime.

The embodiment illustrated in FIG. 10, and generally indicated at 250, is exemplary of an energized emanator assembly 100 according to certain principles of the invention. Every illustrated and described element is encompassed within an embodiment 100. Embodiment 250 includes an energizing mechanism 102 similar to those described above, in combination with a flameless, exothermic, chemically activated emanating device 252. A workable emanating device 252 may be constructed by infusing treatment fluid 162 into a commercially available hand warmer. Energy from a flame 156 operates to enhance broadcast of vapor from the emanating device 252. The illustrated combination 250 can provide a powerful release of treatment fluid in vapor form for an extended period of time. It is within contemplation that a container of treatment fluid 168, and/or a treatment fluid in solidized form 162′, may also be included in an emanator assembly 250, or other embodiments disclose herein.

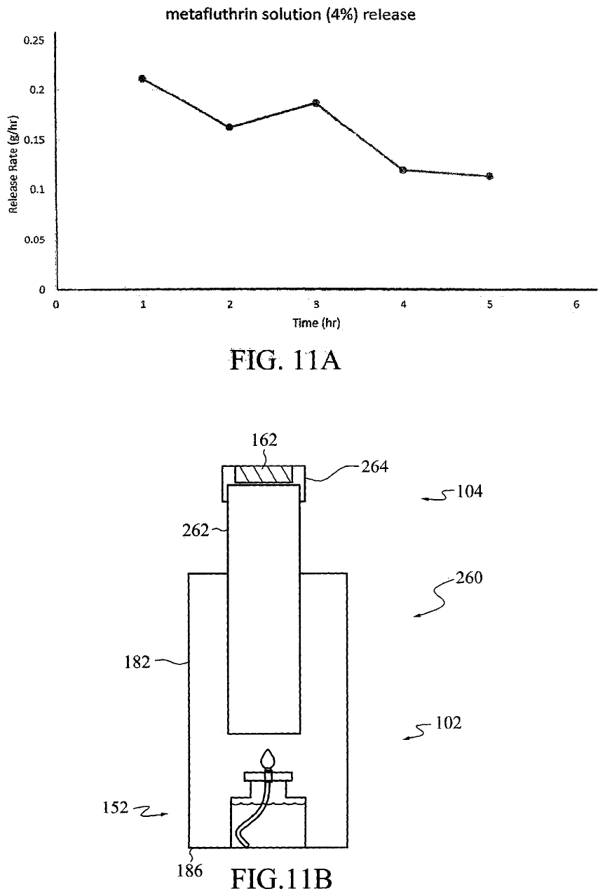

FIG. 11A is a time-based X-Y plot of emanation data produced by operation of the embodiment illustrated in FIG. 11B. The embodiment illustrated in FIG. 11B, and generally indicated at 260, is exemplary of an energized emanator assembly 100 according to certain principles of the invention. Every illustrated and described element is encompassed within an embodiment 100. Elements of a tested assembly 260 included an Aluminum chimney 262 telescopically registered for reciprocation in housing 182. Housing 182 was made from Stainless Steel mesh screen, and had a diameter of about 2 inches. Chimney 262 had a diameter of about 1 inch, and a length of about 5 inches. The bottom of chimney 262 was suspended about 2 inches from the support base 186. An emanator element 104 was carried on top of Aluminum chimney tube 262 by way of a screen cap 264. The cotton emanator 104 was loaded with 1.176 gms of metofluthrin solution 162, and the assembly 260 was placed onto a lit candle lantern 252. Candle lantern 252 was about 1.5 inches in diameter, and about 1.5 inches from its base to the bottom of the flame. Weight of the assembly 260 was periodically monitored throughout the test. The hourly change in emanator weight was calculated and is set forth in FIG. 11A.

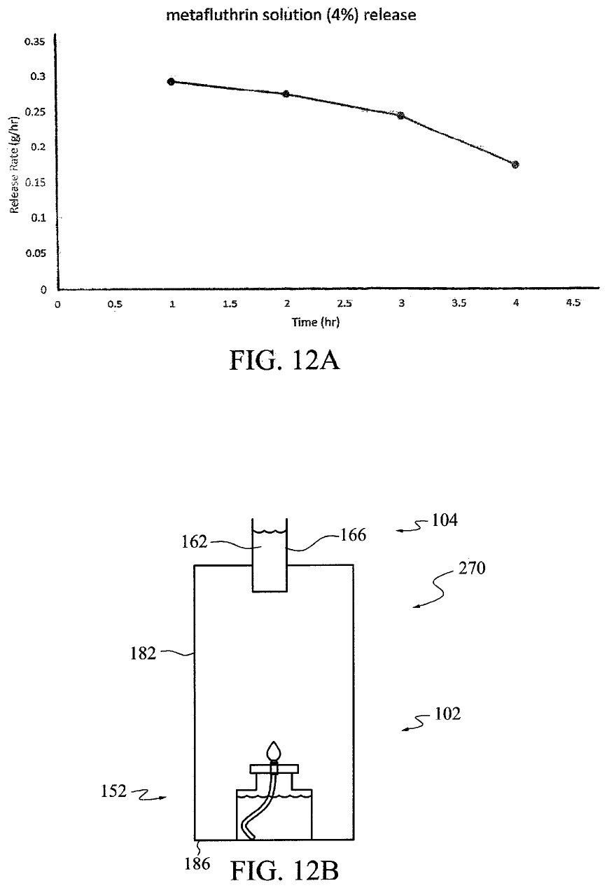

FIG. 12A is a time-based X-Y plot of emanation data produced by operation of the embodiment illustrated in FIG. 12B. The embodiment illustrated in FIG. 12B, and generally indicated at 270, is exemplary of an energized emanator assembly 100 according to certain principles of the invention. Every illustrated and described element is encompassed within an embodiment 100. 1.017 gms of metofluthrin 4% was placed into a glass bottle 166, and the bottle 166 was placed into a thimble-like socket formed to a depth of about ½ inch in the top of the mesh or screen 5 inch tall housing 182. The bottle 166 was about 25 mm in diameter, 55 mm in height, and its open top was about 20 mm in diameter. Bottle wall thickness is estimated to be about 2-3 mm. The assembly was then placed onto a lit candle 252. Weight of the assembly 270 was periodically monitored throughout the test. The hourly change in emanator weight was calculated and is set forth in FIG. 12A.

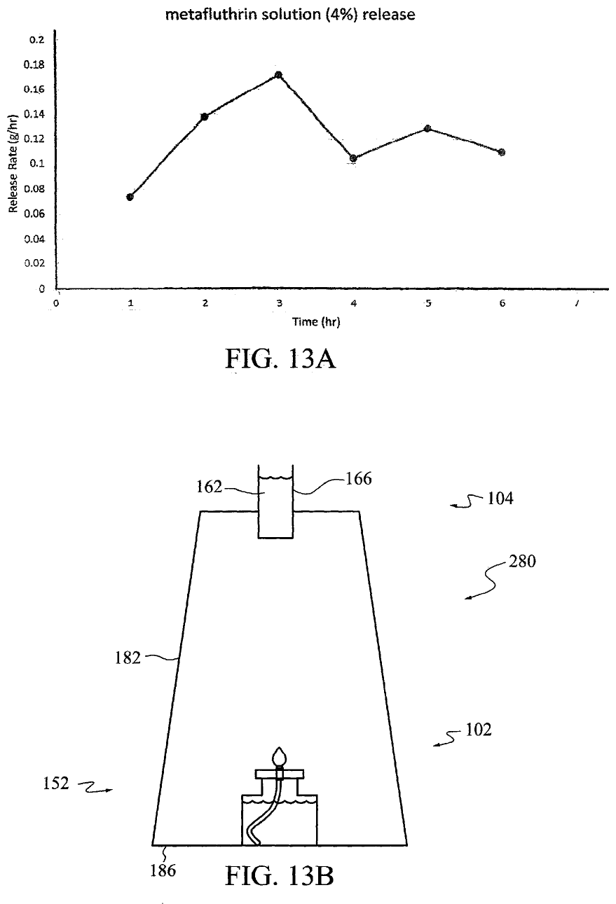

FIG. 13A is a time-based X-Y plot of emanation data produced by operation of the embodiment illustrated in FIG. 13B. The embodiment illustrated in FIG. 13B, and generally indicated at 280, is exemplary of an energized emanator assembly 100 according to certain principles of the invention. Every illustrated and described element is encompassed within an embodiment 100 illustrated in FIG. 1. Elements of a tested assembly 280 are similar to those in assembly 270. A similar open-topped bottle 166 was used in both of embodiments 270 and 280. The approximately 6 inch tall screen housing 182 was formed into a slight conical shape, again with a thimble of about ½ inch deep to hold the bottle 166. The assembly 280 was placed onto a lit candle lantern 252. Weight of the assembly 280 was periodically monitored throughout the test. The hourly change in emanator weight was calculated and is set forth in FIG. 13A.

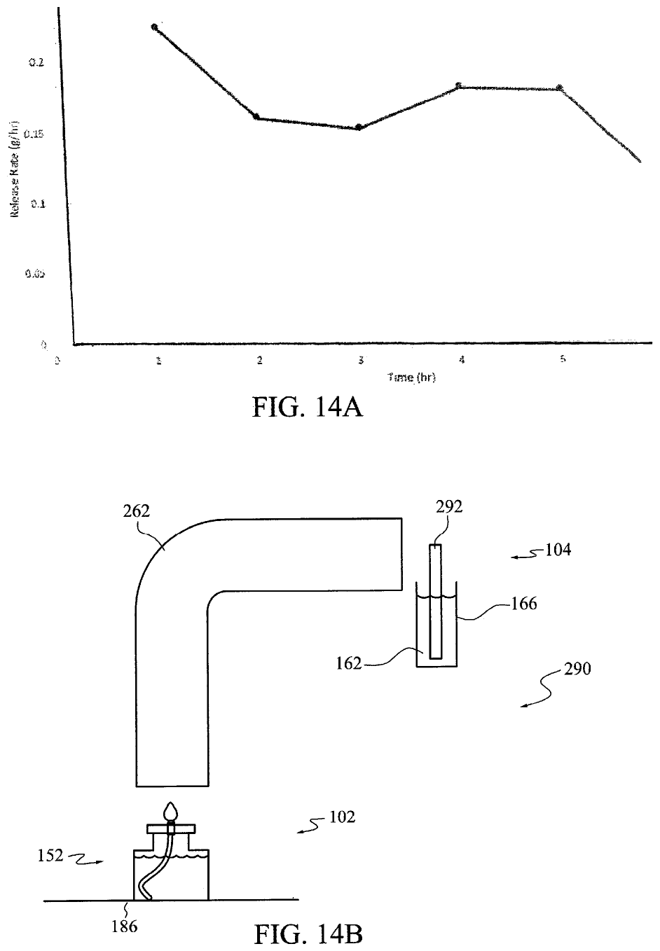

FIG. 14A is a time-based X-Y plot of emanation data produced by operation of the embodiment illustrated in FIG. 14B. The embodiment illustrated in FIG. 14B, and generally indicated at 290, is exemplary of an energized emanator assembly 100 according to certain principles of the invention. Every illustrated and described element is encompassed within an embodiment 100. Elements of a tested assembly 290 include a 1 inch diameter Aluminum chimney 262 that was bent at about a 90 degree corner to dispose 4 inch long legs in vertical and horizontal directions, respectively. For purpose of conducting the test, individual elements were supported from clamps and linkages attached to chemistry stands. The assembly 290 was placed in operable association with a lit candle lantern 252. Heat from the candle lantern 252 caused air flow through the Aluminum tube 262, and heated the wick 292 to volatize fluid 162. Moving warm air piped through the chimney 262 also promoted evaporation from the surface of fluid 162 in the bottle 166. Weight of the assembly was periodically monitored throughout the test. The hourly change in weight of emanator 104 was calculated and is set forth in FIG. 14A.

While aspects of the invention have been described in particular with reference to certain illustrated embodiments, such is not intended to limit the scope of the invention. The present invention may be embodied in other specific forms without departing from its spirit or essential characteristics. For one example, one or more element may be extracted from one described or illustrated embodiment and used separately or in combination with one or more element extracted from one or more other described or illustrated embodiment(s), or in combination with other known structure. The described embodiments are to be considered as illustrative and not restrictive. Obvious changes within the capability of one of ordinary skill are encompassed within the present invention. All changes which come within the meaning and range of equivalency of the claims are to be embraced within their scope.

What is claimed is:

1. An apparatus, comprising:
a source of heat to produce heat at a first location;
a container to hold a volatile substance, a portion of the container being disposed in a heat conducting path extending to the first location;
a quantity of volatile substance disposed inside the container;
a heat conducting element configured and arranged to facilitate volatizing the volatile substance by heat from the source of heat;
an emanator element associated with the volatile substance and configured to release volatized substance in vapor phase into an ambient gas environment; and
a removable seal element configured to resist undesired broadcast of fluid in vapor phase from the apparatus.

2. The apparatus according to claim 1, wherein:
volatile substance disposed inside the container is configured in a nonliquid form to resist spill of liquid from the apparatus.

3. The apparatus according to claim 1, wherein:
the container operates as the emanator element, and the emanator element comprises a volume in which to hold a portion of the quantity of volatile substance.

4. The apparatus according to claim 1, further comprising:
a holder configured to position the container at a desired location that is spaced apart by at least about two inches from the first location.

5. The apparatus according to claim 4, wherein:
the holder comprises a chimney configured to focus circulation of air heated at the first location for contact of heated air with the container, the chimney establishing a distance of at least three inches between the first location and the volatile substance.

6. The apparatus according to claim 5, wherein:
the chimney is arranged to direct flow of heated air toward the container such that a vector defining median air flow direction for heated air in the vicinity of the container is disposed at an angle with respect to vertical; and
the source of heat comprises a flame.

7. The apparatus according to claim 6, wherein:
the angle is greater than about 25 degrees.

8. The apparatus according to claim 6, wherein:
the angle is greater than about 45 degrees.

9. The apparatus according to claim 1, wherein:
the heat conducting element comprises an elongate heat transfer element with a first end portion disposed for contact with the heat source at the first location, and a second end portion disposed to transfer heat from the first location to the volatile substance, the elongate heat transfer element having a thermal conductivity greater than about 100 w/(m deg.K).

10. The apparatus according to claim 4, wherein:
the holder is configured to permit a user to vary a distance between the source of heat and the volatile substance.

11. The apparatus according to claim 1, wherein:
the source of heat comprises paraffin oil; and
the first location is at a flame produced by burning the paraffin oil.

12. The apparatus according to claim 1, wherein:
the emanator element is carried by a chimney structured to telescopically reciprocate with respect to a base to vary a distance between the source of heat and the volatile substance.

13. The apparatus according to claim 1, wherein:
the apparatus is constructed of sufficiently low-cost elements as to permit disposal after one-time-use, and for operation for a maximum period of time of less than about 8 hours.

14. The apparatus according to claim 1, wherein:
the apparatus is constructed for start and stop on-demand operation over a plurality of individual time periods, a sum of the individual time periods providing a maximum total time of operation that is greater than about 100 hours without requiring refueling.

15. The apparatus according to claim 1, wherein:
the volatile substance is in liquid phase and is confined in the container;
a first portion of a wick is dipped into the volatile fluid;
a second portion of the wick is disposed external to the container to operate as an emanator element; and
a metallic heat conducting element is disposed between the source of heat and the second portion of the wick.

16. An apparatus, comprising:
an oil lamp sized to hold only that amount of fuel that permits the lamp to feed a flame for 8 hours or less by wicking the fuel from a lamp storage compartment to the flame to produce heat;
a container for volatile fluid, a portion of the container being disposed to receive heat from the flame;
a quantity of volatile fluid disposed inside the container;
a holder to dispose the container at an operable elevation above, and distance from, a top of the flame;
an emanator element associated with the volatile fluid and configured to release the volatile fluid in vapor phase into an ambient gas environment; and
a removable seal element configured to resist undesired broadcast of fluid in vapor phase from the apparatus prior to intended use of the apparatus, wherein:
the holder is configured to provide a height-adjustable path between the flame and the container.

17. The apparatus according to claim 6, wherein:
the volatile fluid is stored in the container in solidized form to resist spilling of liquid from the apparatus.

18. The apparatus according to claim 16, further comprising:
a heat conducting element comprising an elongate element with a first end portion disposed for contact with the flame, and a second end portion disposed to transfer heat from the flame to the fluid, the elongate element having a thermal conductivity greater than about 100 w/(m deg.K).

19. The apparatus according to claim 16, wherein:
the container operates as the emanator element, and the emanator element comprises a volume in which to hold the quantity of fluid.

20. An apparatus, comprising:
a source of combustible fuel arranged for burning the fuel in a flame to produce heat;
a container for volatile substance;
a quantity of volatile substance disposed inside the container;
an emanator element associated with the volatile substance and configured to release volatile substance in vapor phase into an ambient gas environment responsive to application of heat from the flame to volatile substance disposed in the emanator element or container;
a chimney configured and arranged to direct a convection air current along a non-vertical path from the vicinity of the flame toward the emanator element; and
a removable seal element configured to resist undesired broadcast of volatile substance in vapor phase from the apparatus prior to intended use of the apparatus.
